(19) United States
(12) Patent Application Publication
(10) Pub. No.: US 2015/0019229 A1
(43) Pub. Date: Jan. 15, 2015

(54) Using Voice Commands To Execute Contingent Instructions

(71) Applicant: Robert D. Fish, Tustin, CA (US)

(72) Inventor: Robert D. Fish, Tustin, CA (US)

(21) Appl. No.: 14/051,165

(22) Filed: Oct. 10, 2013

Related U.S. Application Data
(60) Provisional application No. 61/712,032, filed on Oct. 10, 2012.

(51) Int. Cl. G10L 15/22

(52) U.S. Cl. CPC G10L 15/22
USPC 704/275

(57) ABSTRACT

Apparatus, systems and/or methods can be configured to identify a desired action from a user input, identify a contingency from an audible verbal instruction, initiate a check for satisfaction of the contingency, and initiate the desired action if the contingency is deemed to be satisfied.

This application claims priority to U.S. provisional application Ser. No. 61/712,032 filed Oct. 10, 2012, the disclosure of which is incorporated herein in its entirety.

### FIELD OF THE INVENTION

The field of the invention is human-machine interactions.

### BACKGROUND

Humans are well adapted to communicate with each other using voice, but doing so to operate electronic and other devices can be problematic. Among other things, interpreting commands expressed in different languages, lingos, pronunciations, inflections, voice speeds and other voice-related factors can be quite difficult. Early attempts to do so are reflected in US20020069063 (Buchner), US20030212364 (Mann), U.S. Pat. No. 6,633,235 (Hsu) and U.S. Pat. No. 6,101,473 (Scott).

Interestingly, none of those early teachings appreciated that voice commands through cell phones could be used to control either functions of the cell phone itself, or other devices. The present applicant invented that idea back in the 2000 time frame, and a patent finally issued in 2012 from one of the corresponding application. See U.S. Pat. No. 8,165,867 (Fish). Years later Apple™ also filed or acquired several patent applications on a similar concept, which is now embodied in their Siri™ interface. See for example U.S. Pat. No. 6,847,959 (Arrouye) and U.S. Pat. No. 8,086,604 (Arrouye).

The above-referenced patents, as well as all other extrinsic items referenced herein, are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply. Citation of these references is not an admission that any of the information provided herein is prior art or relevant to the presently claimed invention, or that any publication specifically or implicitly referenced should be construed as prior art.

Interestingly, in all of that previous work it appears that where multiple devices are involved in executing voiced instructions (whether phrased as commands, questions, query strings, or in any other manner), either there are no contingencies involved, or where there is a contingency then whatever device is receiving the instruction (the receiving device) from the user, completes its activities without being delayed by waiting for satisfaction of the contingency.

For example, my U.S. Pat. No. 8,165,867 patent contemplates that a cell phone (receiving device) could be used to instruct a television (executing device) to turn to a particular channel. The cell phone immediately forwards the received instruction to a distal server (another executing device), which interprets the instruction, and then sends an appropriate command to the television to turn to the desired channel. In that example there are multiple devices involved, but no contingencies. As contemplated herein, contingencies are characterized by “if-then”, “when-then” or equivalent language.

Transmission of the instruction to the distal server is done immediately upon receipt of the instruction by the receiving device, which would be considered “expeditious” herein even if delayed by factors that do not arise from the contingency, including for example other tasks being concurrently executed by the cell phone, lack of Internet connectivity, loss due to due to transmission or other glitches, high network traffic, demand on the Siri™ computing facilities, etc.

In another example, one could use a cell phone or other remote to instruct a video recorder to record an entire season of a particular IV show. Even though the various recordings will take place over several months, the work done by the cell phone or other remote (as the receiving device) is completed right away. The receiving device does not wait for satisfaction of availability of the various different shows (or any other contingency), and certainly not based upon any logic derived in part or in whole from the instruction.

To distinguish the prior art further, it is known for cell phones and other electronic devices to include various simplistic apps that can remind a user to do something based on a location or a date/time. For example, cell phone apps are known that can play a chime or issue some other alert if the cell phone is carried out of a given geographical region, or a given date/time is reached. In those cases there is a contingency involved, but the cell phone or other device receiving the instruction is the only device involved. The cell phone receives the instruction, figures out the contingency, stores the instruction as a correlation of contingency and action, determines when the contingency is satisfied, and executes that action—all without involvement of other devices.

It is contemplated, however, that there could be numerous advantages to systems, apparatus and methods in which multiple devices are involved in executing voiced instructions based on contingencies arising from the content of the instructions. Among other things, many contingencies may require interaction of different devices for (1) receiving an instruction from which a contingency is derived, (2) figuring out what the contingency is, (3) storing the instruction as a correlation of contingency and action, (4) determining when the contingency is satisfied, and (5) executing the desired action(s).

### SUMMARY OF THE INVENTION

The inventive subject matter provides apparatus, systems and methods in which: an audible verbal instruction is received from a first device, the instruction is utilized to identify a contingency and a desired action; a second, different, device is engaged to accomplish at least one of the following functions (1) define the contingency, (2) store the instruction as a correlation including at least the contingency and the desired action, (3) provide input with respect to satisfaction of the contingency, (4) determine whether the contingency is satisfied, and (5) execute the desired action; and if the contingency is deemed to be satisfied, then perform or at least initiate performance of the desired action.

In preferred embodiments, the contingency is expressed by a contingency phrase such as “if’, “when”, “whenever”, and “in the event that’, or equivalents in English or some other language. All suitable manner of contingencies are contemplated, including for example, one or more of: existence of at least one of a physical object; existence of a digital object stored in a memory; occurrence of an event; attendance of an event by one or more persons; sound or light patterns; a signal from a sensor; presence of an object in a geographical region; a physical activity accomplished at least in part by a person; disjunctively or conjunctively coupled factors; and static or variable contingencies.

Identification of the contingency can be accomplished in any suitable manner, but is preferably accomplished by deriving the contingency from a digital representation of the verbal utterance, which is preferably derived by an analog to digital conversion of the utterance. In various contemplated embodiments the digital representation can comprises one or more of: a symbolic representation of a word in the utterance; an attribute of the utterance other than text; and a symbolic representation of an attribute of the utterance other than text.

In the above description, and elsewhere in the application, groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The verbal utterance can be captured in any suitable manner, including for example, one or more of receiving the verbal utterance by a cell phone or some other consumer electronic device having at least one of a telephony capability and a haptic interface.

All suitable manner of desired actions are contemplated, including for example, one or more of: instructing a consumer electronic device to perform a task; interacting with an instance of at least one of text processing software; electronic spreadsheet software; electronic calendar software; text messaging software; and an Internet web page; interacting with at least one of a camera and a microphone; instructing a person to do something; storing a contingency routine derived from a prior verbal utterance; and initiating a stored contingency routine derived from a prior verbal utterance.

In some embodiments the user input can comprise a second verbal utterance, which: can be separated from the prior verbal utterance by any suitable time period (e.g., less than 5 minutes, more than 5 minutes, more than an hour, etc); can be provided by a person different from a person providing the prior verbal utterance; can be provided at a different location from that which the prior verbal utterance was provided; can be provided in a different language from the prior verbal utterance, and/or can be provided through a different device from that through which the prior verbal utterance was made.

The check for satisfaction of the contingency can be initiated in any suitable manner, including for example, one or more of: sending a request for information from a device other than a device in which the electronics is disposed; sending a request for information from a device in which the electronics is disposed; sending a query to a search engine; analyzing data corresponding to at least part of an image; engaging a robot to perform a function; querying a human being; and activating a probe.

In various embodiments, the apparatus, system or method can be further configured to: inquire about a criterion to be used to determine whether the contingency is satisfied; determine a definition of a term used to describe the contingency; and/or initiate the action or a second action, when the contingency is deemed to be close to being satisfied.

The desired action can be initiated at least in part in any suitable manner, including for example, one or more of: sending a request for information from a device other than a device in which the electronics is disposed; sending a request for information from a device in which the electronics is disposed; sending a query to a search engine; analyzing data corresponding to at least part of an image; engaging a robot to perform a function; querying a human being; sending an instruction to a human being; sending an instruction to a robot; sending an instruction to store a contingency routine derived from a prior verbal utterance; and sending an instruction to execute a contingency routine derived from a prior verbal utterance.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of an embodiment of the inventive subject matter.

FIGS. 2-4 are schematics of sample data structures.

### DETAILED DESCRIPTION

The inventive subject matter provides apparatus, systems and methods in which: an audible verbal instruction is received from a first device, the instruction is utilized to identify a contingency and a desired action; a second, different, device is engaged to accomplish at least one of the following functions (1) define the contingency, (2) store the instruction as a correlation including at least the contingency and the desired action, (3) provide input with respect to satisfaction of the contingency, (4) determine whether the contingency is satisfied, and (5) execute the desired action; and if the contingency is deemed to be satisfied, then perform or at least initiate performance of the desired action.

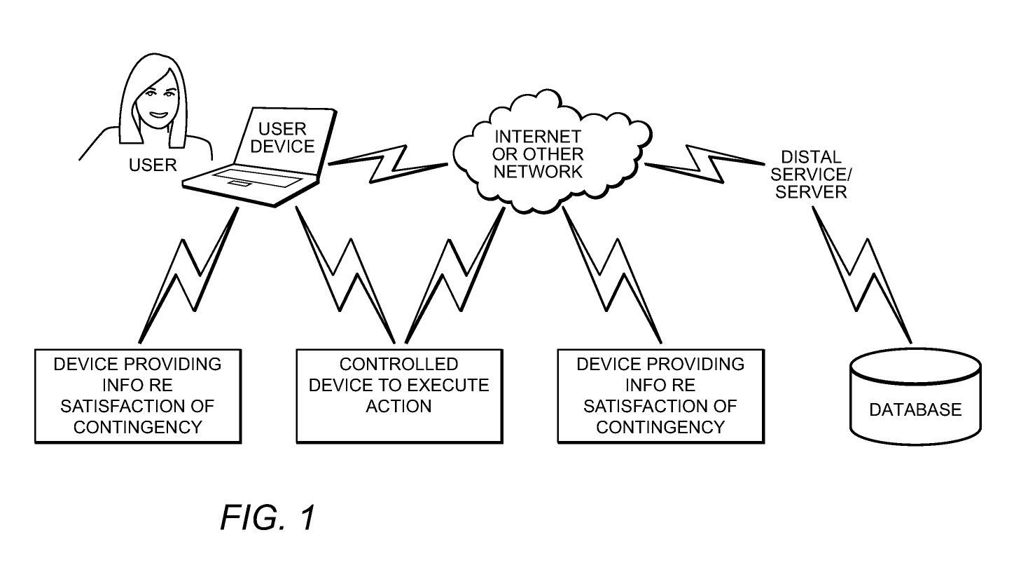

Structure embodying such apparatus, systems and methods is depicted in FIG. 1, in which the USER DEVICE corresponds to the first device or the receiving device, the DEVICE PROVIDING SATISFACTION OF CONTINGENCY corresponds to the second device, and the CONTROLLED DEVICE TO EXCLUDE ACTION corresponds to a device, which could be the first or second device, or another device, which is initiated to perform the desired action.

The “USER DEVICE” in FIG. 1 should be interpreted generically as any device that can receive a voice command, including for example a cell phone, PDA or other hand-held device, a phablet, an electronic gaming game player, or a laptop or desktop computer, in each case having an internal or externally coupled microphone. FIG. 1 shows one USER and one USER DEVICE, but should be interpreted as generically depicting one or more such USERS and USER DEVICES.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are deemed to be synonymous.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The software instructions preferably configure a computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

Accordingly, in FIG. 1, the INTERNET OR OTHER NETWORK” should be interpreted generically to include one more networks. Similarly in FIG. 1 the DISTAL SERVICE/SERVER and DATABASE should be interpreted generically to include one or more DISTAL SERVICE/SERVERS and DATABASES, respectively.

### Verbal Utterances

As used herein “audible verbal utterances” are sounds made by a human voice in a manner that could be heard by another person if that person were standing nearby. Audible verbal utterances are preferably made in a conversational manner in a human language such as English, French, Japanese, Chinese, etc, but may or may not utilize conventional grammar. In preferred embodiments audible verbal utterances are made “live” directly or indirectly to the USER DEVICE, and in other embodiments might also be recorded, and then provided at a later time to the USER DEVICE.

As used herein “audible verbal utterances” excludes recitation of computer code, such as statements of Visual Basic, C#, Python or other structured coding languages.

### Contingencies

In preferred embodiments, contingencies are expressed by a contingency phrase such as “if’, “when”, “whenever”, and “in the event that’, or equivalents in English or other languages.

Contemplated contingencies can relate to any one or more of physical and non-physical objects, including for example the existence of data stored in a localized or distributed memory. Contemplated contingencies can relate to one or more events, including for example a concert, an auto accident, someone arriving at work, or someone saying something. Events can be characterized by any parameter that can be sensed, by humans or otherwise, including a sound, (whether audible, subsonic vibration, supersonic or otherwise), a vibration, a light pattern a smell, and a biometric parameter, as for example a blood pressure, pulse, breathing rate, PO₂ level, and so forth. Contingencies can also relate to a location, such as presence of an object in a geographical region. Contingencies can also relate to occurrence of a physical activity accomplished at least in part by a person, as for example filing of a tax return, legal brief or other submission, issuance of a ruling, and publication of a book or a speech.

Contemplated contingencies can involve only a single relationship, or can be disjunctive or injunctive. Examples of disjunctive contingencies are shown below:
“If the car going too fast or Joan is driving, then . . . ”
“If the car going too fast or Joan is driving or it is nighttime, then . . . ”

Examples of injunctive contingencies are shown below:
“If the car is going too fast and Joan is driving, then . . . ”
“If the car going too fast and Joan is driving and it is nighttime, then . . . ” >

There can also be contingencies that include both disjunctive and injunctive contingencies. An example is shown below:
“If the car is going too fast and Joan is driving, or Joan is driving and it is nighttime, then . . . ”

Contemplated contingencies can be fixed, or can vary, based on time, location, condition, presence of a person or a device, operation of a person or a device, or other factor. An example is shown below:

“If Mary is driving the car today, then . . . , but if Mary is driving the car tomorrow, then . . . ”

Contingency routines can be derived from a current utterance, or at least partially derived from a prior verbal utterance. Where multiple utterances are involved, they can be separated by any reasonable period of time, including less than a minute, one to five minutes, more than five minutes, and more than 24 hours. Multiple utterances used to construct a contingency routine can be provided in multiple languages, from different devices, and even by one or more individuals. Stored contingency routines can be displayed, shared, modified, activated, deleted, and so forth.

### Checking for Satisfaction of a Contingency

Checking for satisfaction of a contingency can be accomplished in any suitable manner. For example, a check can be initiated at least in part by sending a request for information from a device other than a device in which the electronics is disposed. In that case the various devices could be coupled via Bluetooth™ or other short distance communication, by local and/or wide area network, hard wire, etc. Checks can be initiated at least in part by sending a request for information from a device in which the electronics that receive the contingency command is disposed, or from a different device. Checks can be initiated at least in part by sending a query to a search engine, by analyzing video, audio, textual or other data. Checks could be performed in such device or devices through any suitable physical motion, thought process, or otherwise. Contemplated robots could be physically embodied, or could be entirely software. Checks can be initiated at least in part by querying a human being, as for example asking a person to check for a fare to Europe, and displaying or otherwise rendering an answer. Checks can be initiated at least in part by activating a probe.

The “DEVICE PROVIDING INFO RE SATISFACTION OF CONTINGENCY” in FIG. 1 should be interpreted generically to include any suitable device or devices providing information regarding satisfaction of a contingency, and can for example, be electronic, mechanical, living beings, robots or any combination of these. FIG. 1 shows two such devices, which could be different or the same device or devices.

### Determining Whether A Contingency Is Satisfied

It is contemplated that in some instances the system will not know how to determine whether the contingency is satisfied, and will have to further inquire from the user about which criterion is to be used, and what the threshold for satisfaction is. Where multiple thresholds are used, the system can employ fuzzy logic or other multivariate analysis. Thus, a contemplated system might inquire “What do you mean by “red”?” In some embodiments, the system might audibly seek clarifying information from the user as to a condition precedent for satisfaction of the contingency, or as to a time frame after which the contingency is deemed to not be satisfied, or as to an alternative action to be accomplished if the contingency is deemed to not be satisfied.

### Actions

The action to be performed can be any sort of task or set of tasks. Examples of actions that can be initiated by a cell phone include altering a security setting, contacting an address, sending a message, retrieving a message, setting a timer, conducting a search, identifying a person or other object from an image. Other contemplated actions include interacting with an instance of at least one of text processing software, electronic spreadsheet software, electronic calendar software, text messaging software, and an Internet web page. Specific examples include interacting with Microsoft Word™, Excel, PowerPoint, or Outlook, Apple Pages™, Twitter™, Facebook™, and Google™. Other contemplated actions include interacting with a camera and/or a microphone. Still other contemplated actions include instructing a person to do something, as for example, travel to a location, eat, sleep, comb hair, read, write, listen, exercise, take a medicine, begin or stop a project, or contact another person, a company a school, or a governmental agency.

It is contemplated that the system can initiate execution of multiple different actions, or of the same action multiple times. Thus, a contingency might be to remind a child to go bed if he has not done so by 10:00 pm, and also to advise the parent that that child has not yet gone to bed.

Actions can be initiated in any suitable manner. For example, actions can be initiated at least in part by sending a request for information from a device other than a device in which the electronics is disposed, via Bluetooth™ or other short distance communication, by local and/or wide area network, hard wire, etc. Actions can be initiated at least in part by sending a request for information from a device in which the electronics is disposed, or from a different device. Actions can be initiated at least in part by sending a query to a search engine, by analyzing video, audio, textual or other data. Actions can be initiated at least in part by engaging a robot to perform a function, which could be a physical motion or otherwise. Contemplated robots could be physically embodied, or can be entirely software. Actions can be initiated at least in part by querying a human being, as for example asking a person to action for a fare to Europe, and display or otherwise render and answer. Actions can be initiated at least in part by activating a probe.

The “CONTROLLED DEVICE TO EXECUTE ACTION” in FIG. 1 should be interpreted generically to include any suitable device or devices that can execute or initiate execution of a desired action, and can for example, be electronic, mechanical, living beings, robots or any combination of these. FIG. 1 shows one such device, which should be interpreted generically as including one more similar or different such devices.

It is also contemplated for a device to confirm with a user whether the user still wants to proceed with the desired action. For example, if a contingency has been pending for a relatively long period of time, which might be hours, days, weeks or months depending upon the circumstance, the system might inquire of the user, either audibly or using text, whether the user still wants that contingency to be active. An another example, when it appears that a contingency is satisfied or is about to be satisfied, the system might inquire of the user, either audibly or using text, whether the user still wants to execute the previously designated desired action. Either of those instances allows a user to change his/her mind before the desired action is taken.

It is contemplated that a system could initiate the action or a second action when the contingency is deemed to be close to being satisfied. Still other contemplated actions can initiate a cascade of actions, or spawn initiation of one or more other stored routines. For example, one contingency might be to remind the user to take a particular drug if the system detects that a blood pressure or other biometric of the user falls above or below a threshold. And another contingency might be that if the user has been reminded to take the drug, and has not done so for some period of time, then remind the user again, or perhaps contact a caregiver to follow up.

It is contemplated that active contingencies could be edited or deleted.

It is still further contemplated that the system could trigger an action that the person setting up the contingency doesn't even know about, or is in some other manner indefinite. For example, a contingency could be set up that if the user ever gets to Chicago, remind him about things that might be of interest to a visitor. Upon execution, the system could key on the word “visitor” to check a Chicago visitor database, and depending on what it finds, suggest that the user visit the Science & Technology Museum.

It is still further contemplated that the system might engage the user in a conversation regarding the action/suggestion. For example, the user might say “I'm only going to be here one day”, and the system might respond “Then you might prefer a walk along the lake. The Science & Technology Museum takes several days to visit adequately.” The additional information for that comment could have been derived from the visitor database utilized earlier, or from some other related or unrelated database. Detection of environment of the user, user preferences, and communication protocols could be accomplished in any suitable manner, but could advantageously be accomplished in accordance with the teachings of my co-pending application, “Electronic Personal Companion”, U.S. utility application Ser. No. 13/952,058.

### Stored Routines

As mentioned above, routines comprising contingencies and actions are preferably stored as routines, essentially mini-verbal apps.

If a user has not already provided a name or other designation for a given stored routine, the system can inquire as to name. Users can preferably view their stored routines on a smart phone, or any suitably capable consumer electronic device having at least one of a telephony capability and a haptic interface local to the user. Using such an interface a user can preferably control the status (start, stop, active, inactive, etc) of at least one of the routines using the electronic device. Both control over stored routines, and at least some information relating to creating and/or maintaining a stored routine could be provided through a keyboard, mouse or other non-audibly operated interface.

On the server or service end, the system can provide an infrastructure through which the user can share the routine with one or more other users. Thus, one user might create a stored routine that checks for occurrence of a set of terms in a news article, and upon that occurrence send the article to the user's cell phone, or initiate a previously stored second routine derived from a second verbal utterance interpreted to include a second contingency and a second action.

Along with stored routines, the system could also store a history of activity by a user, and then determine whether a contingency is satisfied in part based upon that history, or perhaps alter a planned action based at least in part upon that history. It is still further contemplated that determination of whether a contingency is satisfied could in part be based upon a history or another entity (person or group or organization) and/or a planned action could be based at least in part upon the history of that other entity.

Processing can be accomplished in any suitable manner. For example, analog to digital conversation of audible speech could be accomplished on a cell phone, and the digital representation could be sent to a distal service (cloud based or otherwise) for parsing into words. There will need to be some sort of data structure that stores the routines, and supporting information. For example, when executing a routine that takes an action based on “Mary driving too fast”, there has to be a data structure that provides information as to which Mary this particular user is talking about, and the source of information (perhaps electronics in Mary's car or cell phone) from which the desired information can be derived.

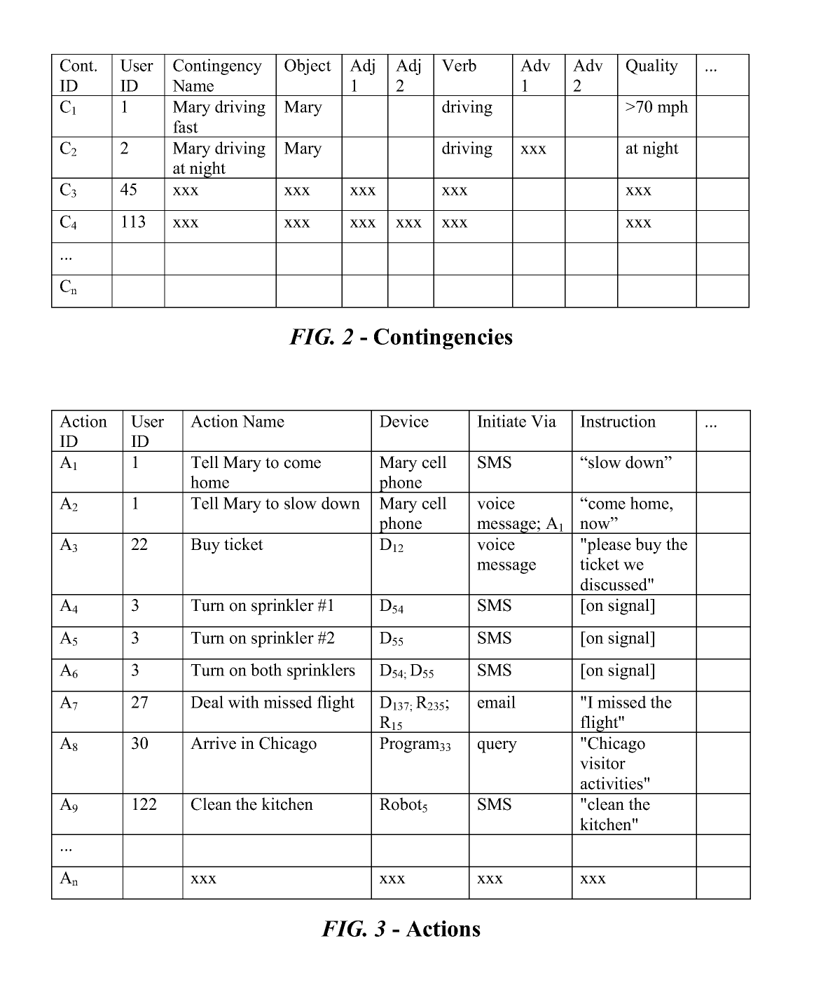

Sample data structures to store such information for contingencies, actions, and routines are depicted in FIGS. 2-4, respectively The xxx should be interpreted as actual data, appropriate for the cells in which the xxx is found. The data structures are depicted here as flat tables, however, XML or any other suitable data structures could also be used.

The rows in FIG. 2 represent stored information for specific contingencies, numbered C₁ to Cₙ. Column 1 stores IDs for the contingencies, and Column 2 stores IDs of the users to which the contingencies relate. Other tables (not shown) would be joined with the table in FIG. 2 to provide contact and other information regarding the user. Column 3 stores corresponding Contingency Names, which are preferably given by the user, in response to a query by the system. The remaining Columns 4-10, store the specifics of the contingencies according to parts of speech. The Adj and Adv headings in FIG. 2 refer to adjectives modifying the Object, and adverbs modifying the Verb, respectively.

For example, the contingency C₁, named “Mary driving fast”, is satisfied when “Mary” (the Object of the contingency) “is driving” (Verb) “more than 70 miles per hour” (quality). Similarly, the contingency C₂, named “Mary driving at night”, is satisfied when “Mary” (the Object of the contingency) is “driving” (Verb) “at night” (quality). The “xxx” in Column 8 could be an adverb relating to driving, as for example “recklessly”.

The table of FIG. 2 should be interpreted to include other columns (designated by the ellipsis in the column name field) needed to store other aspects of other contemplated contingencies.

The rows in FIG. 3 represent stored information for specific actions, numbered A₁ to A. The number of rows in the tables of FIGS. 2, 3 and 4 need not have any relation to one another.

Column 1 stores an IDs for the actions, and Column 2 stores IDs of the users to which the actions relate. Other tables (not shown) would be joined with the table in FIG. 3 to provide contact and other information regarding the user. Column 3 stores corresponding Action Names, which are preferably given by the user, in response to a query by the system. Column 4 stores devices which are to perform the various actions, Column 5 stores paths through which the actions are to be taken, and Column 6 stores instructions to be given through the corresponding devices via the corresponding paths.

Rows A₁ and A₂ are not related to any particular contingency. Row A₁ stores the action of sending the SMS message “slow down” to Mary's cell phone. Row R₂ stores the action of sending the SMS message “come home, now” to Mary's cell phone, and also cascades to the action A₁.

In Row A₃ the cell for Column 4 contains a reference to device D₁₂, which identifies a device in a joined table (not shown), rather than a literal device name. The Action of Row A₃ is to send the voice message “please buy the ticket we discussed” to device D₁₂.

Rows A₄ and A₅ specify the actions of sending electronic “on” signals (designated in the database as [on signal]) to devices D₅₄ and D₅₄, respectively, via SMS messages. Row A₆ specifies the action of sending electronic “on” signals (designated in the database as [on signal]) to both devices D₅₄ and D₅₄, via SMS messages.

Row A₇ specifies the action of sending an email to device D₁₃₇ saying “I missed the flight”, and also triggers routines R₂₃₅ and R₁₅, which might, for example, initiate other actions depending on time of day or other contingencies.

Row Ag specifies the action of triggering a computer program identified as Program₃₃ to query Google™ or other searching service or agent, and report back on “Chicago visitor activities”.

Row A₉ specifies the action of triggering sending an SMS message to a robot identified as Robot₅ to “clean the kitchen”.

Taken literally, the table of FIG. 3 is focusing just on actions that involve sending messages through devices. However, all suitable manner of devices and actions are contemplated as described elsewhere in this specification, and accordingly the table of FIG. 3 should be interpreted to include other columns (designated by the ellipsis in the column name field) needed to store other aspects of other contemplated actions.

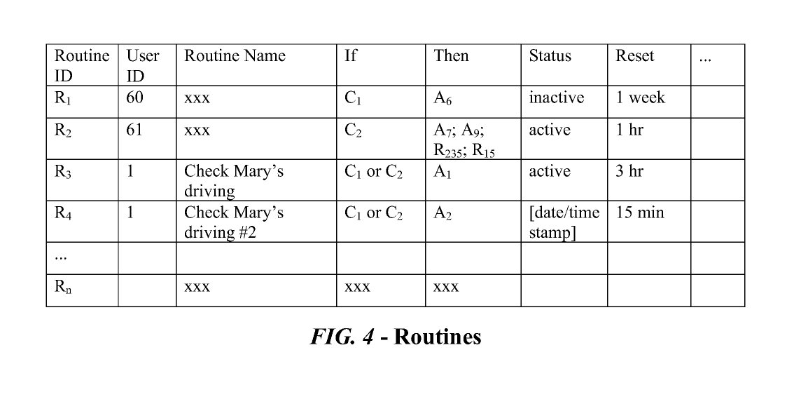

The rows in FIG. 4 represent stored information for specific routines, numbered R₁ to Rₙ, and basically links contingencies with actions.

Column 1 stores IDs for the routines, and Column 2 stores IDs of the user to which the routines relate. Other tables (not shown) would be joined with the table in FIG. 4 to provide contact and other information regarding the user. Column 3 stores corresponding Routine Names, which are preferably given by the user, in response to a query by the system.

Each routine links one or more contingencies identified in Column 4 with one or more actions identified in column 5, and is active or inactive depending on the status shown in Column 6. Thus, for example, while R₂ is active and contingency C₂ is satisfied, actions A₇; A₉ are initiated, and routines R₂₃₅; R₁₅ are activated. Similarly, while R₃ is active, then satisfaction of either C₁ or C₂ will initiate action A₁. While R₄ is active, then only satisfaction of both C₁ and C₂ will initiate action A₁.

Once the contingency (or contingencies) of a routine is (or are) satisfied, that routine is put on hold for the reset period stored in Column 7. A date/time stamp is put into the corresponding cell of Column 6, so that the routine can be re-activated after the reset period has expired.

As with each of the other tables shown herein, the table of FIG. 4 should be interpreted generically. Thus, the table of FIG. 4 should be interpreted to include other columns (designated by the ellipsis in the column name field) needed to store other aspects of other contemplated routines.

In the discussion above, and elsewhere in the application, the recitation of ranges of values is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system comprising at least one electronic processor collectively running at least one computer program stored in at least one computer readable memory, and receiving user inputs, collectively configured to:
receive an audible verbal instruction via a receiving device;
utilize the instruction to identify a contingency and a desired action;
utilize a second device different from the receiving device to accomplish at least one of the following functions (1) define the contingency, (2) store the instruction as a correlation including at least the contingency and the desired action, (3) provide input with respect to satisfaction of the contingency, (4) determine whether the contingency is satisfied, and (5) execute the desired action;
initiate a check for satisfaction of the contingency; and
if the contingency is deemed to be satisfied, then initiate the desired action.

2. The system of claim 1, wherein the contingency is expressed by a contingency phrase selected from the list consisting of “if’, “when”, “whenever”, and “in the event that’.

3. The system of claim 1, wherein the contingency comprises existence of at least one of a physical object and a digital object stored in a memory.

4. The system of claim 1, wherein the contingency comprises occurrence of at least one of an event attended by multiple persons, and a physical activity accomplished at least in part by a person.

5. The system of claim 1, wherein the contingency comprises occurrence of at least one of a sound pattern and a light pattern, and a signal from a sensor.

6. The system of claim 1, wherein the contingency comprises occurrence of a presence of an object in a geographical region.

7. The system of claim 1, wherein the digital representation of the verbal instruction comprises at least one of a symbolic representation of (a) a word in the instruction and (b) an attribute of the instruction other than text

8. The system of claim 1, wherein the receiving device has at least one of a telephony capability and a haptic interface.

9. The system of claim 1, wherein the action comprising instructing a consumer electronic device to perform a task.

10. The system of claim 9, wherein the consumer electronic device has at least one of a telephony capability and a haptic interface.

11. The system of claim 1, wherein the action comprising interacting with an instance of at least one of text processing software, electronic spreadsheet software, electronic calendar software, text messaging software, and an Internet web page.

12. The system of claim 1, wherein the action comprising interacting with at least one of a camera and a microphone.

13. The system of claim 1, wherein the action comprising instructing a person to do something.

14. The system of claim 1, wherein the action comprising at least one of storing and initiating a contingency routine derived from a prior verbal instruction.

15. The system of claim 1, further comprising separate electronic interfaces that receive the user input and the verbal instruction.

16. The system of claim 1, wherein the check is initiated at least in part by sending a request for information from a device other than a device in which the electronics is disposed.

17. The system of claim 1, wherein the check is initiated at least in part by sending a query to a search engine.

18. The system of claim 1, wherein the check is initiated at least in part by analyzing data corresponding to at least part of an image.

19. The system of claim 1, wherein the check is initiated at least in part by querying a human being.

20. The system of claim 1, wherein the desired action is initiated at least in part by sending a request for information.

21. The system of claim 1, wherein the desired action is initiated at least in part by analyzing data corresponding to at least part of an image.

22. The system of claim 1, wherein the desired action is initiated at least in part by sending an instruction to a human being.
